(19) United States
(12) Patent Application Publication
(10) Pub. No.: US 2026/0008191 A1
(43) Pub. Date: Jan. 8, 2026

(54) Apparatus for Setting Hair Clipping Length

(71) Applicant: Irving Barber Company LLC, La Habra, CA (US)

(72) Inventors: Richard Mathew Toone, Brea, CA (US); Sean Ramirez, Orange, CA (US); Naru Santhan, Brea, CA (US)

(73) Assignee: Irving Barber Company LLC, La Habra, CA (US)

(21) Appl. No.: 19/254,814

(22) Filed: Jun. 30, 2025

Related U.S. Application Data
(60) Provisional application No. 63/667,636, filed on Jul. 3, 2024.

(51) Int. Cl. B26B 19/38; B26B 19/20

(52) U.S. Cl. CPC B26B 19/3813; B26B 19/20

(57) ABSTRACT

A universal hair clipper guard is disclosed that accommodates hair clippers with varying fixed comb lengths. The guard includes a comb section with a front castle structure, a central tang, and at least two outer tangs. The outer tangs are designed to match longer, industry-standard fixed combs, while the central tang, featuring a pliable hinge and a short-aft-stop, is configured to deflect when used with a long comb or drop into place to engage with shorter combs. This allows a single clipper guard to be used across different hair clipper models and manufacturers, simplifying inventory and disinfection in commercial settings. Optional magnet receptacles for securing the guard to the clipper are also described.

### BACKGROUND

Hair clippers appear to have been first invented around 1855 by a Serbian barber named Nikola Bizumić. Nikola's hair clipper was a mechanical device that transferred to a moving blade force created by the squeezing of a lever against a fixed handle. The hair clipper itself included a fixed stationary blade and the moving blade which traversed back and forth across the fixed blade. The blades had castled edges with a sharpened edge around the castle structures.

A gentleman by the name of Leo Wahl invented the first electric hair clipper. His company is still around today and manufactures hair clippers and various accessories under his family name. The company, today, is called the Wahl Clipper Corporation.

One of the issues with hair clippers is that the clippers themselves need to be physically offset from a person's scalp in order to avoid excessively cutting hair. Of course, this is not an issue when the hair clipper is being used by the military to, essentially, shave a recruit's hair before entering boot camp.

The solution to this problem was the development of a “clipper guard”.

Different companies that manufacture hair clippers have, as expected, adopted various lengths for their stationary and oscillating blades. This, of course, means that each manufacturer is able to produce clipper guards of their own design, which fit only their particular hair clippers. Even though stationary and oscillating blades all retain one common feature, that being the castled cutting structure, the length from the castled cutting structure to the aft portion of the blades may vary considerably from manufacturer to manufacturer.

In a commercial barbershop or hair salon, this means that a barber or stylist may not be able to borrow clipper guards from their neighbor in the same shop unless their neighbor also uses the same brand and model of a hair clipper. Again, this would force a particular barbershop to either provide the same manufacturer and model of hair clippers to all of their barbers and hairstylists. Otherwise, different sets of clipper guards would need to be provided to various stations within the same shop. This can become cumbersome, especially when considering the need for bulk disinfection of clipper guards. If different types of clipper guards are disinfected together, there is the tedious task of separating disinfected clipper guards according to different brands and models of hair clippers.

### BRIEF DESCRIPTION OF THE DRAWINGS

Several alternative embodiments will hereinafter be described in conjunction with the appended drawings and figures, wherein like numerals denote like elements, and in which:

FIG. 1 is a perspective view of the fixed portion of a hair clipper,

FIG. 2 is a perspective view of an assembly of the comb coupled to a hair clipper cradle;

FIG. 3 is a perspective view of one example embodiment of a universal clipper guard;

FIG. 4 is a side cross-section view of a universal clipper guard coupled to a hair clipper having a long fixed comb;

FIG. 5 is a perspective view of a universal clipper guard coupled to a hair clipper having a comb of length less than that of a long fixed comb;

FIG. 6 is a side cross-section view of a universal clipper guard coupled to a hair clipper having a short fixed comb; and

FIG. 7 is a perspective view of the underside of one example embodiment of a universal clipper guard;

### DETAILED DESCRIPTION

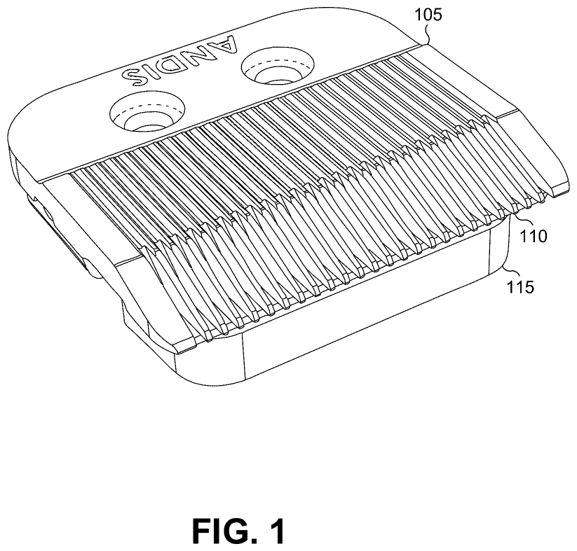

FIG. 1 is a pictorial diagram that illustrates a fixed portion of a hair clipper, which is called a comb. As illustrated, a hair clipper includes a comb 105. The comb 105 comprises a castle structure 110 which is used to separate clusters of hair fibers from other clusters. As the comb moves along a scalp, a plurality of hair clusters are guided toward an oscillating blade. The oscillating blade moves back and forth orthogonally to the castle structure 110. In this example, the comb 105 is attached to a hair clipper cradle 115. The hair clipper cradle 115 provides a mechanism for conveying mechanical force to the oscillating blade.

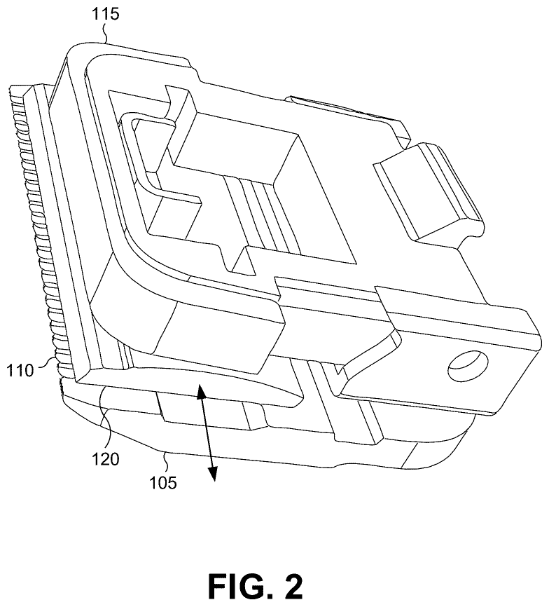

FIG. 2 is a pictorial diagram that illustrates the assembly of the comb to a hair clipper cradle. According to various illustrative structures, the comb 105, which is attached to the hair clipper cradle 115, is stationary relative to an oscillating blade 120. As already described, the cradle 115 provides a mechanism for receiving mechanical force, for example from an electric motor, and conveying the mechanical force to the oscillating blade 120. It should be appreciated that, according to various illustrative structures, mechanical force is converted into oscillating motion that is uncoupled to the oscillating blade 120. As clusters of hair move through the castle structure 110 included in the fixed comb 105, they encounter the oscillating blade 120. The oscillating blade 120 then cuts the clusters of hair according to a length dictated by the height of the castle structure 110 included in the comb 105. It should be appreciated that, because of the need for a long-lasting blade, both of the fixed comb 105 and the oscillating blade 120 are typically constructed of steel.

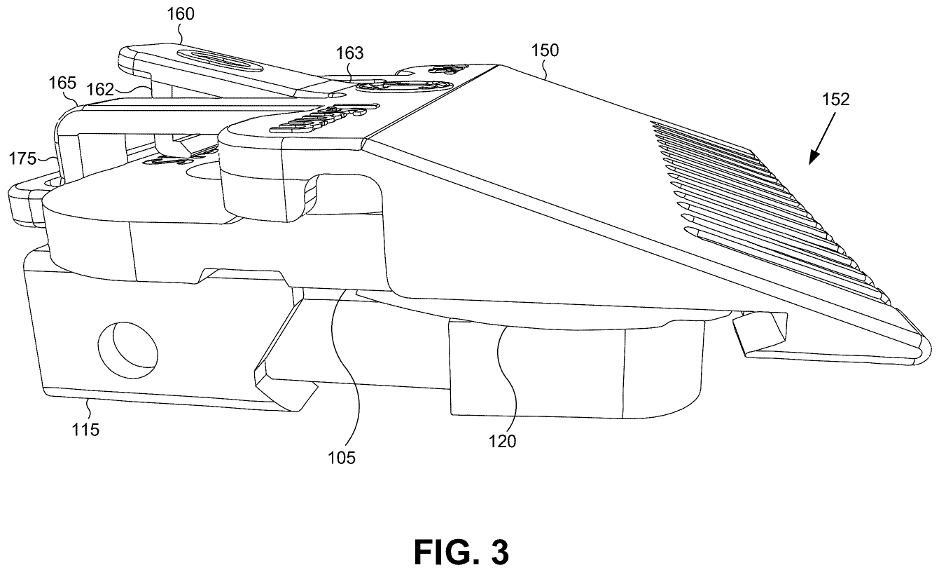

FIG. 3 is a pictorial diagram that illustrates one example embodiments of a universal clipper guard. It should be appreciated that, according to various embodiments of hair clippers, different types of hair clippers will have a fixed comb with varying lengths from the castle structure 110 included in the comb 105 to the asked end of the comb 105. As should be appreciated, there exists a maximum length of such a comb 105. The maximum length of such a comb 105 is readily established within the industry. However, there are a wide variety of other combs that are shorter in length then those of the associated maximum length. FIG. 3 illustrates how a universal clipper guard 150 is attached to a comb 105 of a length associated with an industry standard maximum length.

According to one example embodiment, a universal clipper guard 150 comprises a castle structure 152, a center tang 160 and two or more outer tangs 165. It should be appreciated that, according to this example embodiment of a universal clipper guard 150, the outer tangs 165 include a long-aft-stop 175. It should be appreciated that, according to this example embodiment, long-aft-stop 175 protrudes downward toward the fixed comb 105. It should be appreciated that according to one alternative embodiment, the length of outer tangs 165 corresponds to the length associated with the industry standard maximum length, which is 27.3 mm. In an alternative embodiment, the industry standard maximum length is between 26.3 mm and 28.3 mm, inclusive of these end points. It should also be appreciated that other lengths are specified by other alternative embodiments of the universal clipper guard 150.

This example embodiment further includes a short-aft-stop 160. The short-aft-stop 160 protrudes downward toward the fixed comb 105. In those illustrative use cases where the universal clipper guard 150 is mounted on a hair clipper that includes a long 105, the center tang 160 is deflected away from an upper surface included in the fixed comb 105. This occurs when a bottom end of the short-aft-stop 162 is pressured upward away from the fixed comb 105. To enable the center tang to be deflected away from the upper surface of the fixed comb 105, the center tang 160 includes a pliable hinge 163.

According to various alternative embodiments, the universal clipper guard 150 is fabricated by way of an injection molding process. One example alternative embodiment provides that the universal clipper guard 150 is molded using an amorphous polymer. According to various alternative example embodiments, the pliable hinge 163 is realized by molding the entire universal clipper guard 150 using an amorphous polymer that exhibits a glass transition temperature approximately 10 C lower than ambient, which is approximately in the range 20 to 25 C. By using a low glass transition material, sufficient stiffness is achieved to enable the universal clipper guard 150 to retain its shape, but also allows for a pliability necessary to enable the center tang 160 to deflect.

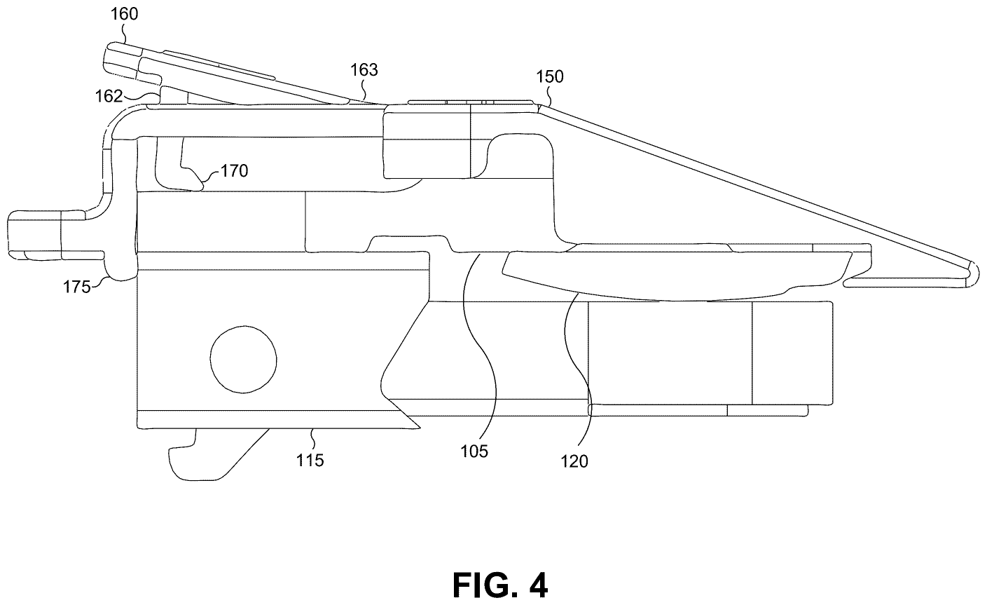

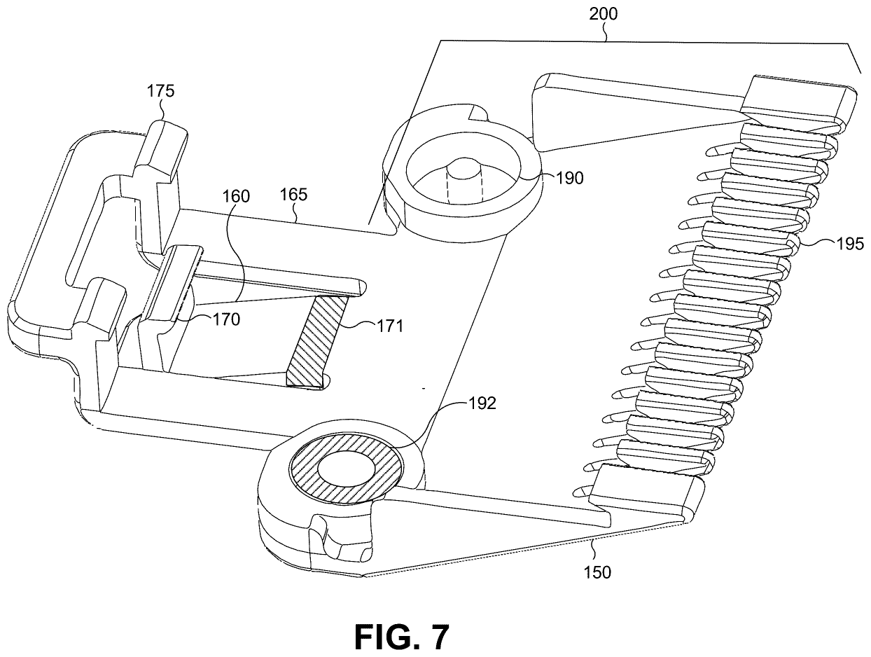

FIG. 4 is a pictorial view of a cross-section depicting installation of a universal clipper guard onto a hair clipper having a long fixed comb. As depicted in this figure, the fixed comb 105 is affixed to the hair clipper cradle 115. The oscillating blade 120 is sandwiched in between the fixed comb 105 and the cradle 115. As already described, the oscillating blade 120 oscillates transversely to the castle structure 110 included in the fixed comb 105. When the universal clipper guard 150 is attached to a hair clipper having a comb of a length associated with a maximum comb length, the short-aft-stop 162 forces the center tang 160 upward and away from the comb 105. As heretofore described, deflection of the center tang 160 is enabled by an included pliable hinge 163 disposed at a forward portion of the center tang and which connects to a body portion of the universal clipper guard 150. In one alternative embodiment, the pliable hinge comprises a region of amorphous polymer infused with a plasticizer. This results in a region (see 171 in FIG. 7) that exhibits a glass transition temperature approximately 10 C lower than ambient, while maintaining higher stiffness in the remainder of the structure.

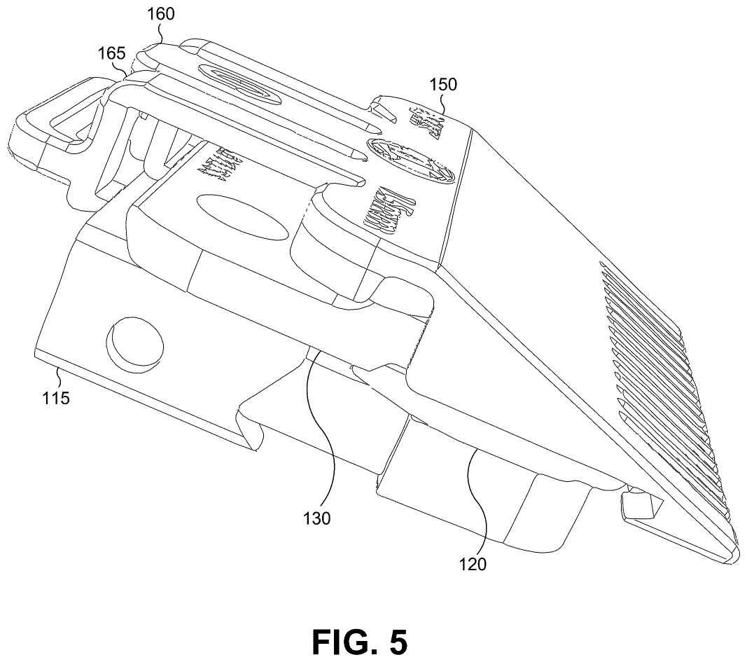

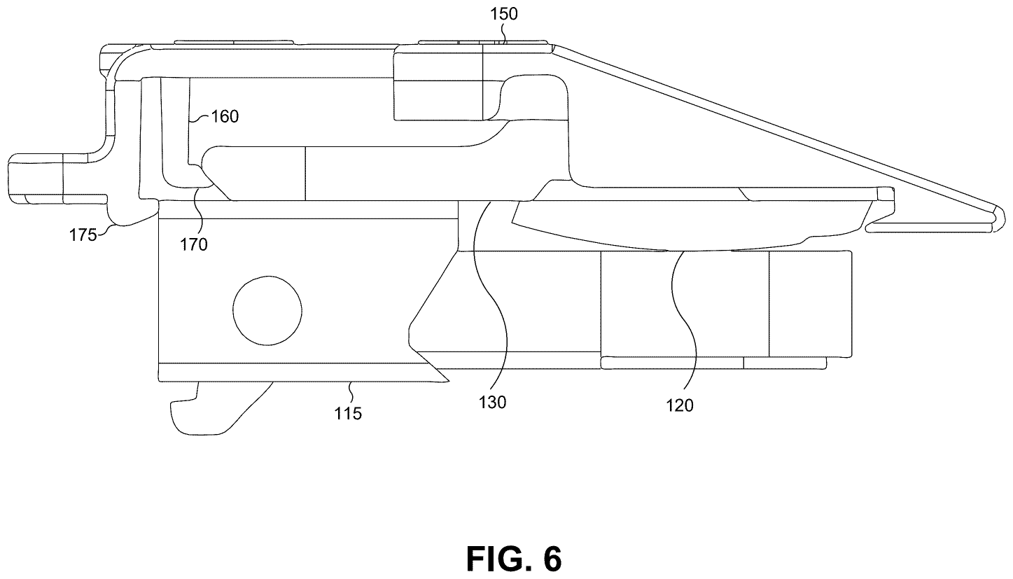

FIG. 5 is a pictorial diagram that illustrates installation of a universal clipper guard onto a hair clipper having a fixed comb of length less than that of a long fixed comb. FIG. 6 is a cross-section that illustrates installation of a universal clipper guard onto a hair clipper having a fixed comb of length less than that of a long fixed comb. As illustrated, when the universal clipper guard 150 of this example embodiment is installed onto a hair clipper having a short comb 130, the center tang 160 drops down parallel with the outer tangs 165. In this example embodiment, as shown in FIG. 6, the center tang 160 includes the short-aft-stop 160. In one alternative example embodiment, the short-aft-stop 160 terminates in a catch 170, which clips onto a back portion of a short comb 130. The catch 170 emanates forward from the bottom portion of the short-aft-stop 160. In yet another alternative example embodiment, the catch 170 includes a tapered edge at its forward extremity, which corresponds to a tapered edge included in a short comb 130. FIG. 6 also demonstrates that the short comb 130 is affixed to the cradle 115 and that an oscillating blade is disposed between the cradle 115 and a bottom surface of the short fixed comb 130.

FIG. 7 is a pictorial illustration depicting an underside of a universal clipper guard. According to one alternative example embodiment, the universal clipper guard further includes one or more magnet receptacles 190, which receive magnets proximate to a lower surface of the universal clipper guard 150. According to yet another alternative example embodiment, the universal clipart guard 150 further includes one or more magnets 192 installed in the magnet receptacles 190. According to various illustrative use cases, the magnets secure the universal clipart 152 a top surface of the comb 105 included in a hair clipper.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A hair clipper guard comprising:
a comb section that includes a front castle structure that corresponds to a castle structure included in a hair clipper stationary comb;
a center tang oriented away from the front castle structure and protruding to a distance corresponding to a short stationary comb, said center tang comprising a pliable hinge disposed at a point where the center tang begins to protrude from the comb section;
a short-aft-stop stop protruding downward from an aft end of the center tang;
at least two outer tangs oriented away from the castle structure straddling the center tang and protruding to a distance corresponding to a long stationary comb; and
at least two long-aft-stops, one protruding downward from an end of each outer tang.

2. The hair clipper guard of claim 1 wherein the outer tangs protrude to match an industry standard maximum of fixed comb being a length of 27.3 mm.

3. The hair clipper guard of claim 1 wherein the outer tangs protrude to match an industry standard maximum of fixed comb being between 26.3 mm and 28.3 mm, inclusive of these end points.

4. The hair clipper guard of claim 1 wherein the clipper guard comprises a molded assembly based on an amorphous polymer that exhibits a glass transition temperature 10C lower than ambient.

5. The hair clipper guard of claim 1 wherein the center tank includes a region proximate to the comb comprising an amorphous polymer blended with a plasticizer that exhibits a glass transition temperature 10C lower than ambient.

6. The hair clipper guard of claim 1 further comprising:
one of more magnet well for holding a magnet disposed on a bottom surface of the comb section.

7. The hair clipper guard of claim 6 further comprising:
one or more magnets installed in each of the magnet wells.
